(19) United States
(12) Patent Application Publication
(10) Pub. No.: US 2015/0004585 A1
(43) Pub. Date: Jan. 1, 2015

(54) Method and Apparatus for the Dynamic Generation of Scientific Problems from a Primary Problem Definition

(71) Applicants: Aniruddha Das, San Marcos, CA (US); Shweta Suryanna Shetty, San Diego, CA (US)

(72) Inventors: Aniruddha Das, San Marcos, CA (US); Shweta Suryanna Shetty, San Diego, CA (US)

(21) Appl. No.: 14/300,197

(22) Filed: Jun. 9, 2014

(51) Int. Cl. G09B 7/00; G09B 23/00; H04L 29/06

(52) U.S. Cl. CPC G09B 7/00; H04L 67/42; G09B 23/00
USPC 434/276

(57) ABSTRACT

A method and apparatus for the dynamic generation of one or more scientific problems derived from a primary scientific problem is disclosed. In one embodiment, a computerized device is configured to receive an input of a primary scientific problem comprising a set of variable parameters and at least one physical constraint, and generates at least one related scientific problem by varying the parameter within the limitations of the physical constraint. In an embodiment the primary scientific problem has an associated figure that is dynamically modified for the related scientific problem. Optionally, an answer generator is disclosed that creates solution sets and multiple response solutions for the derived scientific problem. Optionally, a natural language processor and set of rules for validating the derived scientific problem may also be used in conjunction with the disclosed computerized device. In one embodiment, the related scientific problems are derived from user interest or needs.

### BACKGROUND OF THE INVENTION

1. Field of the Invention

The present invention relates to the field of electronic or online education and to the field of generating or publishing scientific problem sets.

2. Description of Related Art

With the proliferation of the internet, the quantity of online educational content that is available has grown significantly. Students these days are learning the Science, Technical, Engineering, and Math (STEM) subjects online with content provided by companies that have become household names, e.g., Khan Academy, Wikipedia, Knewton, Pearson, etc. These companies have systems that present a student with educational content and, often, will adapt the content based on the performance or interest of the students. This results in differentiated learning among students, allowing a personalized learning experience even in large group settings. Recently, many universities such as Stanford University and MIT have started Massively Online Open Courses (MOOCs) that also offer online education to a very large number of students. These MOOCs typically have hundreds and often thousands of students simultaneously taking the same course.

An important aspect of learning the STEM subjects is problem solving. In order to attain proficiency, students typically solve problems assigned to them by the teacher or, in the case of online education, by the software. An individual student may solve hundreds of problems in each course. Each of these online educational content providers typically have databases which contain a large number of problems and, based on the student's needs, different problems are assigned to each student. These problems are typically generated by teachers and other subject matter experts (SME) one by one, usually by hand, and form the core of the content of the problems found standard in STEM textbooks.

With the advent of differentiated learning and personalized education there has been progress made on adapting the lessons, and problem sets, that each student is assigned. Education content providers are moving away from the era when all students in a class solved the same problem sets. Modern (typically online) education content providers are able to provide different students with different problem sets. However, in generating these problem sets, in essence, the content providers choose the appropriate questions for each student from their large database of problems. Thus, the adaptation involved determines whether a particular question is to be given to a particular student rather than in modifying that question to make it appropriate for that student. In other words, the adaptation algorithm chooses different sets of problems for different students, but does not change or adapt the question itself.

In some subjects, typically mathematics, however, there exists prior art that generates a large number of problems by randomly generating some numerical parameter. For example, Peter Rowlett, A Simple Example of Dynamic Graphics, 7 MSOR CONNECTIONS 1 (2007), teaches a method to dynamically generate a triangle with angles that are assigned random values whenever the webpage is reloaded. In this particular case, the triangles are drawn and stored using Scalable Vector Graphics (SVG) which is a format that is specifically designed to accommodate dynamic generation of figures on web browsers. The website www.homeschoolmath.net is another online resource that generates math problem sets randomly. There are many other example websites, with the common element of each being that certain numeric parameters of the problem are randomly generated (e.g., angles of a triangle, coefficients of a polynomial, etc.), thus generating a large, (practically infinite) number of unique problems. Another defining characteristic of these online problem set generators is that the random problems generated ask the same basic problem, just with different numeric quantities. E.g., if the problem asks for the area of a triangle, then all the infinite variants of the problem ask for the area of a triangle, albeit with different parameters of the triangle itself. Thus, when it comes to generating related problems from a primary problem, the prior art generates variants of the primary problems only by using different numbers. To summarize, the prior art teaches dynamic problem set generation by randomizing some numerical parameters of the problem. The prior art does not deal with real life physical constraints (e.g., the presence or absence of friction, or the physical connectivity of multiple objects) and does not change the fundamental question being asked.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 5,870,731 (1999) describes a system and method for an intelligent computer assisted adaptive learning system. The adaptive learning is accomplished by presenting the student with a problem, and increasing or decreasing the difficulty of further problems by determining whether the student correctly answered the question.

U.S. Pat. No. 5,944,530 (1999) describes a computer-aided-educational method and system that considers and monitors a student's concentration level when teaching the student. Through monitoring the student's volitional or involuntary behavior, the system provides an indication on the student's concentration level, and changes study materials or presentation style accordingly.

U.S. Pat. No. 6,112,051 (2000) describes a random problem generator for math and science problems, with the main focus of the application on the random generation of chemical formula problems.

U.S. Pat. App. No. 2009/0017427 (2009) describes an intelligent problem generator that takes an input math problem, analyzes the math problem, and intelligently spawns example problems based on the conditions of the input problem. This problem generator is limited to adapting and changing equations, and does not disclose adaptive figure generation.

U.S. Pat. App. No. 2010/0273138 (2010) describes a computer-implemented method for automatically generating learning exercises. The method generates learning exercises by obtaining a base knowledge level of the student and changing the difficulty of the exercises accordingly.

U.S. Pat. App. No. 2011/0065082 (2011) describes a device, system, and method of educational content generation. This patent application describes a device, system, and method for generating educational content through the selection of templates and layouts, as selected by a user.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### SUMMARY OF THE INVENTION

The present invention provides among other things a computerized system for the dynamic generation of scientific problems from a primary problem definition. In one embodiment it is comprised of a computerized device configured to receive an input of a primary scientific problem, and associated with that primary scientific problem, a set of variable parameters and at least one physical constraint, and then it generates at least one related scientific problem by varying the parameter within the limitations of the physical constraint.

In an embodiment the primary scientific problem has an associated figure that is dynamically modified to draw a related figure for the related scientific problem. Optionally, an answer generator is also disclosed that creates solution sets and multiple response solutions for the derived scientific problem. Optionally, a natural language processor and a set of rules for validating the derived scientific problem may also be used in conjunction with the disclosed computerized device. In one embodiment, the related scientific problems are derived based on user interest or needs.

In an embodiment, the primary scientific problem and the related scientific problems are all stored and generated on the same computerized device. In another embodiment, the primary scientific problem is stored in a first computerized device, a server generates the related scientific problem and associated figures and answers (if applicable), and transmits the related scientific problem to a second computerized device that the student uses. In yet another embodiment, a first computerized device is used to input the primary scientific problem and then transmit the problem to a second computerized device (e.g., a student/user device), which then generates the related scientific problem and serves it to the user.

In an embodiment, a plurality of related scientific problems are generated from the primary scientific problem by a computerized device and are used to create a book or printable sets of questions.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that he can be his own lexicographer if desired. The inventor expressly elects, as his own lexicographers, to use only the plain and ordinary meaning of terms in the specification and claims unless he clearly states otherwise and then further, expressly sets forth the “special” definition of that term and explains how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of pre-AIA 35 U.S.C. §112, ¶6 and post-AIA 35 U.S.C. §112(f). Thus, the use of the words “function,” “means” or “step” in the Detailed Description or Description of the Drawings or claims is not intended to somehow indicate a desire to invoke the special provisions of pre-AIA 35 U.S.C. §112, ¶6 or post-AIA 35 U.S.C. §112(f), to define the invention. To the contrary, if the provisions of pre-AIA 35 U.S.C. §112, ¶6 or post-AIA 35 U.S.C. §112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of pre-AIA 35 U.S.C. §112, ¶6 or post-AIA 35 U.S.C. §112(f). Moreover, even if the provisions of pre-AIA 35 U.S.C. §112, ¶6 or post-AIA 35 U.S.C. §112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 is a flowchart depicting a problem generation process in one embodiment of the present invention.

FIG. 2 depicts a primary scientific problem with a block on a ramp, with a pulley attached to the object, a force of friction, and an external force pulling the block on the ramp.

FIG. 3 depicts a derived block on a ramp with friction as a physical constraint.

FIG. 4 depicts an example GUI of one embodiment of the present invention, allowing the input of a primary scientific problem.

FIG. 5 depicts an example GUI of one embodiment of the present invention, allowing the input of generic answers for the primary scientific problem.

FIG. 6 depicts an example GUI of one embodiment of the present invention, allowing the input of physical constraints for the primary scientific problem.

FIG. 7 depicts an example GUI of one embodiment of the present invention, allowing the input of parameters for the primary scientific problem.

FIG. 8 depicts an example GUI of one embodiment of the present invention, allowing the input of validation rules for the primary scientific problem.

FIG. 9 depicts a hierarchical taxonomy as an example of attributes of physics problem solving in one embodiment of the present invention.

FIG. 10 depicts one system embodiment of the present invention, wherein the primary scientific problem is created and stored on the same computerized device that generates and displays the derived related scientific problems.

FIG. 11 depicts one system embodiment of the present invention, wherein the generation of related scientific problems is accomplished on a server.

FIG. 12 depicts a figure associated with a primary scientific problem comprising an inclined ramp, and containing a block, hoop, and pulley with a mass.

FIG. 13 depicts a generated figure with an inclined ramp containing a block and pulley.

FIG. 14 depicts a generated figure with an inclined ramp and a hoop.

FIG. 15 depicts an example user GUI of one embodiment of the present invention, displaying a generated question with a free response type of user answer.

FIG. 16 depicts an example user GUI of one embodiment of the present invention, displaying a multiple choice answer type of generated question.

FIG. 17 depicts an example user GUI login screen of one embodiment of the present invention.

FIG. 18 depicts an example user GUI of one embodiment of the present invention, displaying a student dashboard allowing a user to select topics from which to be tested.

FIG. 19 depicts an example user GUI of one embodiment of the present invention, displaying a student dashboard allowing a user to select topics to be either tested on, or not tested on.

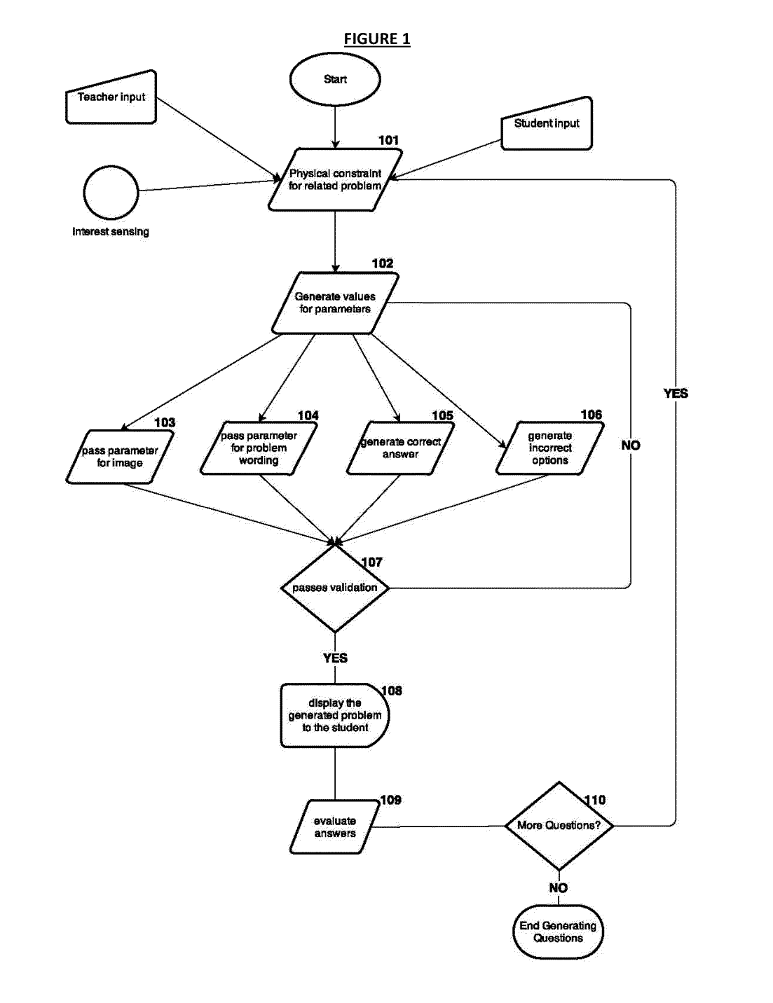

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the invention is not limited to the examples that are described below.

It is desirable to be able to generate a large number of derived problems from a defined primary problem that goes beyond mere randomization of numerical values. As an example, in the field of mechanics in physics, there are numerous physical constraints that define the problem. E.g., the force of friction may or may not be present in the problem. Or the problem may be asking the student to determine velocity, acceleration, time to travel a certain distance, or any of the other parameters commonly evaluated in the field. The object or body that is the subject of the problem itself may vary. In one problem, it could be a point mass, in another, it could be a solid sphere, a cylinder, or a collection of particles. It is desirable to be able to automatically generate derived problems from a primary problem while adhering to the physical constraints. It is also desirable to ask different problems that require the students to be able to solve for different physical quantities (e.g., velocity, energy, displacement etc.), rather than solve for the same quantity with different numerical parameters. This present invention teaches how to do this.

In one application, an embodiment relates to the generation of problems in the field of Newtonian Mechanics in high school physics. Another embodiment relates to the generation of related problems in the field of Electrical Engineering. However, in general the techniques disclosed herein can be applied to the generation of related problems in any scientific field.

When teaching Newtonian Mechanics in high schools, students are usually asked to solve numerous practice problems. Most text books have extensive problem sets following each chapter. In many cases, the problem sets have common elements that gradually get more complicated as the course material progresses. E.g., in the initial chapters, the problems may explicitly exclude the impact of frictional forces whereas in subsequent chapters, the impact of frictional forces may be introduced. Initial chapters may treat objects as ideal point masses, whereas subsequent chapters may include extended bodies. The problems however, often require the student to calculate the same or similar quantities. Some common quantities that students are expected to calculate throughout a typical course in Newtonian Mechanics include “final velocity of an object”, “initial velocity of an object”, “time to travel between two specified points”, “various kinds of energy (e.g., kinetic, potential etc)”, “various kinds of forces that are in effect” and so on.

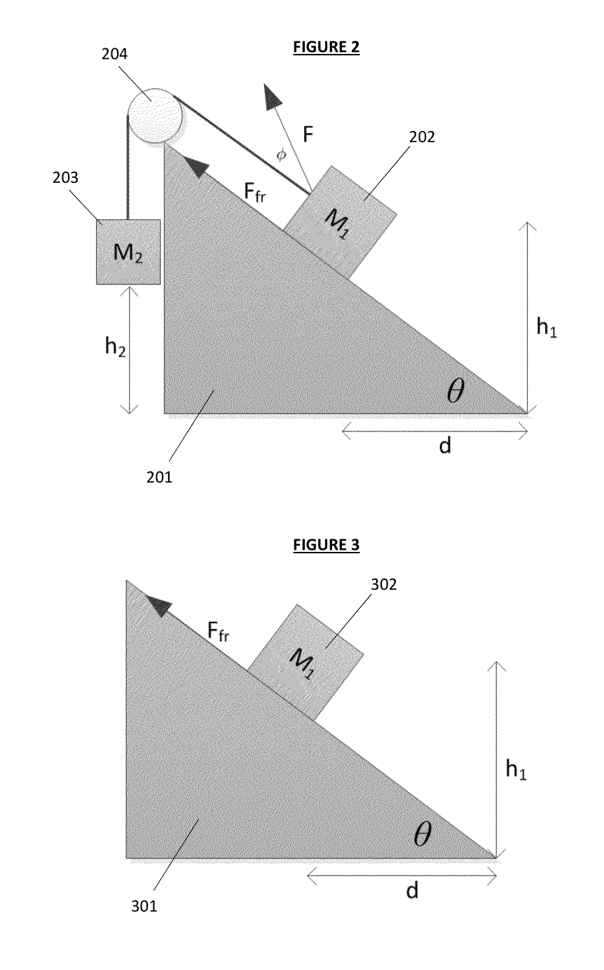

A classic example of a problem in Newtonian Mechanics involves an object on an inclined ramp and asks the student to determine various properties of this object. FIG. 2 and FIG. 3 depict examples of this problem. This problem can be posed with numerous different physical constraints. The object on the ramp could be a point mass, or an extended body such as a solid sphere of radius “R” or other such bodies. The problem could assume friction between the object and the ramp, or could assume that it was frictionless. Referencing FIG. 2, the object on the ramp 202 could be connected to a second object 203 hanging at the end of the ramp via a pulley 204. Or, referencing FIG. 3, that entire pulley and second mass system could be absent, with only the object 302 on the ramp. There could be a force pushing the object up the ramp at a specified angle and so on. The examples above are not exhaustive, but rather exemplary of the type of physical constraints that could be imposed on the problem. In this context, a “physical constraint” is defined as a limitation or requirement of the physical object being described in the problem. A “physical constraint” could refer to limitations or requirements of shape (sphere vs block), existence (presence of pulley or not), characteristic of body (point mass vs extended body), etc. It is worth mentioning, that unlike the prior art of generating numerous mathematical problems from a primary mathematical problem, adoption of physical constraints changes the fundamental problem being asked of the student and is not a mere rephrasing of the same problem with different numbers. This “physical constraint” is a key enabling step of the invention disclosed herein.

In typical physics text books, different chapters might have problems that deal with the basic structure of an object on a ramp, but each problem is individually created by the author. In online physics problem sets, each problem is stored separately in the problem database. This is inefficient and the current invention creates one or more derived problems from a single problem dynamically.

The problem which is the basis from which other problems are derived is referred to as the “primary scientific problem” and the one or more dynamically generated problem(s) is (are) referred to as the “derived scientific problem(s)” or as the “related scientific problem(s)”.

In one embodiment a first computerized device takes as input the primary scientific problem. In the exemplary problem of the “object on the ramp”, the input of the primary scientific problem comprises i) defining the wording of the problem, ii) defining an associated figure, iii) defining a set of one or more physical constraints, iv) defining some variable parameters of the problem, v) a correct answer vi) a set of answer choices, vii) a set of validation rules, and viii) a set of classification tags. In one embodiment the input of the primary scientific problem is via a graphical user interface (GUI). In another embodiment, the input of the primary scientific problem is via a database. In yet another embodiment, the input of the primary scientific problem is via a spreadsheet. It is not required to have each of the i)-viii) specified for each primary scientific problem. A particular primary scientific problem could have one or more of these steps missing. The minimum set required to define a primary scientific problem is a wording of the problem, at least one physical constraint, and at least one variable parameter.

In one embodiment, the definition of the wording of the problem comprises defining the part of the question that remains constant and then defining a list of variables that may change. E.g., the question could ask, “Determine the {variable one} after {variable two} seconds” where {variable one} is a list of parameters such as velocity, kinetic energy, potential energy, momentum, etc., and {variable two} is a list of numbers such as 0, 1, 2, 2.5, etc. Note that depending on the choice of the two variables in the wording of the question, different problems could be asked of the student. In the case of each of the variables, either an exhaustive list of possible values is tabulated, or a rule for the numeric generation of such a particular value is specified. Such rules for numeric generation could include the definition of a random number generator of a particular distribution. A particular primary problem could have one or more problem statements, or wordings.

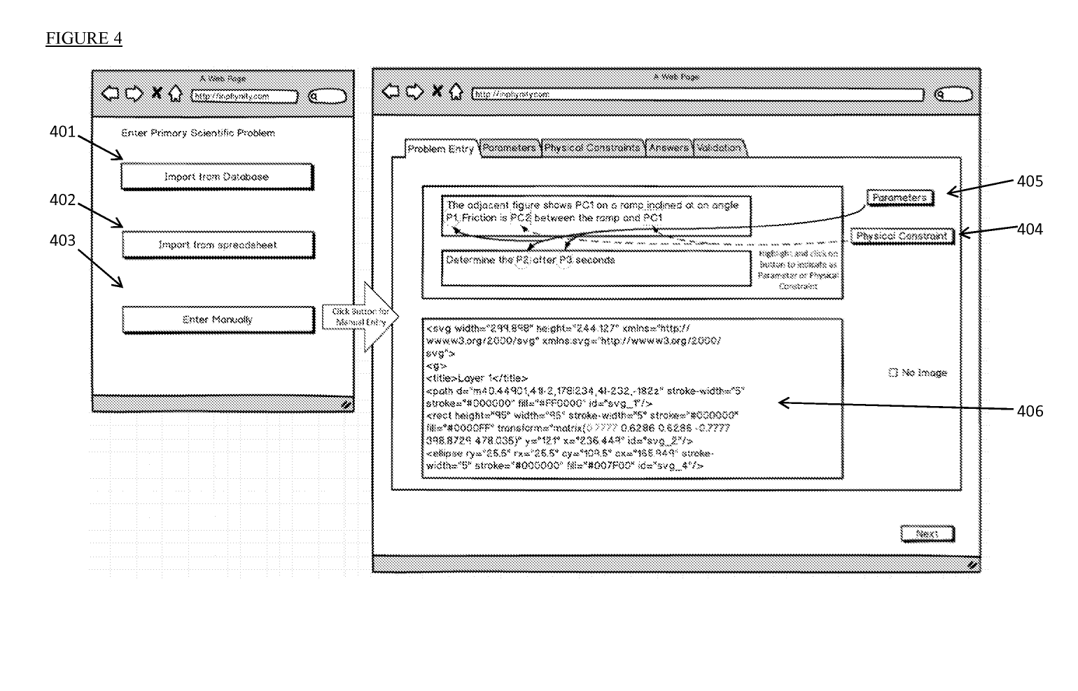

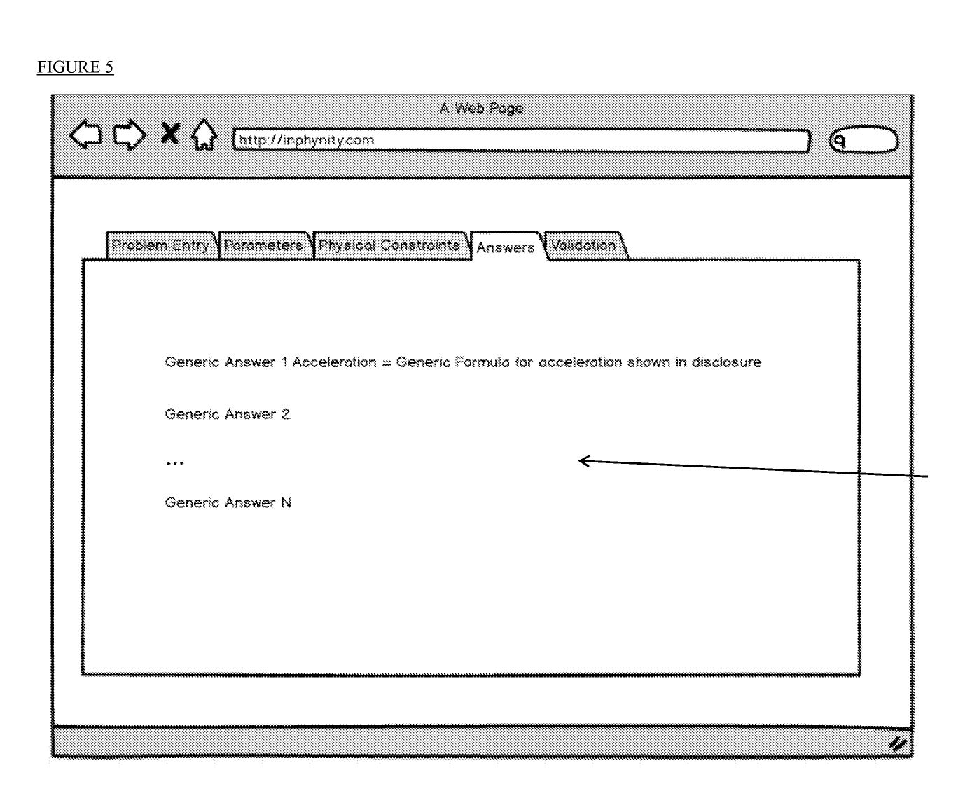

In one embodiment the associated figure is specified as a Scalable Vector Graphic (SVG). Referencing FIG. 4, in one embodiment, the figure could be entered via a Graphical User Interface (GUI) 403 which has a built in SVG editor 406. In another embodiment, the figure could be entered via a database 401. In yet another embodiment, the figure could be entered via a spreadsheet 402. It should be noted here that SVG images can be defined completely via a text file and hence can easily be entered as text in a database or a spreadsheet. Associated with each figures are sets of parameters or attributes that can vary as well as sets of physical constraints. Some exemplary physical constraints are the type of object on the ramp (e.g., whether it is a block or a sphere etc.), the presence or absence of a pulley with a second mass, the requirement of the object and the ramp to touch each other, the requirement of the object to be a certain distance above the horizontal ground level, etc. Some exemplary variable parameters are the length of time after which a specific quantity (e.g., kinetic energy) has to be calculated, the quantity that the problem asks the student to calculate (e.g., kinetic energy, momentum etc.) Scalable Vector Graphics (SVG) is a widely used standard for images that can be rendered dynamically by most modern web-browsers and is especially appropriate for dynamically generated images. Once an image is entered in the computerized device along with the set of parameters and constraints, figures for the related scientific problems can be dynamically generated by using different sets of parameters while adhering to the physical constraints specified. Each primary problem could have none, one, or multiple associated figures. Although SVG is a particular form of vector graphics, and perhaps the most widely used version, other vector graphics formats could also be used without being out of scope of this disclosure. The key necessary enabling feature is the ability to pass parameters to algorithmically modify the image in question.

In an alternate embodiment, the associated figure(s) of the primary scientific problem is(are) specified as multiple figures saved as a .jpeg, .gif or any other format that cannot be dynamically modified. In this embodiment, different variants of the figure have to be stored along with the primary scientific problem each one appropriate for a particular variant of the problem. E.g., there could be one figure where the object on the ramp is a block and a second figure where the object on the ramp is a block that is connected to a second block via a pulley. This embodiment typically requires more storage space compared to what is required when using parameter based dynamic image generation via SVG images.

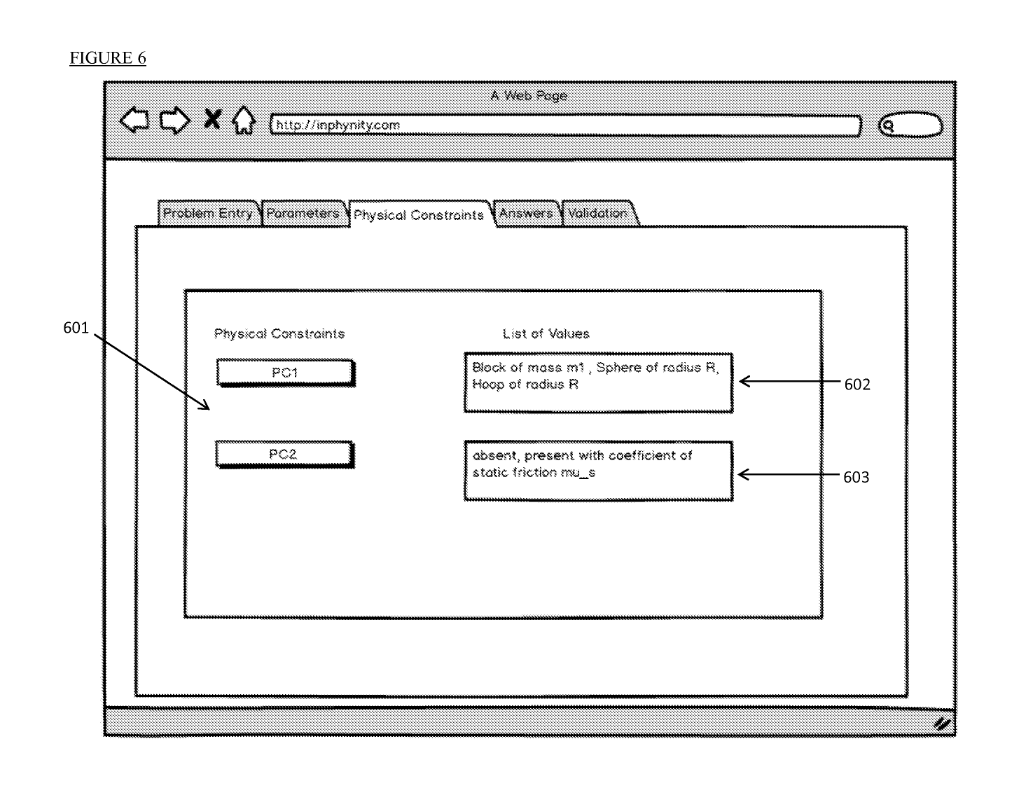

Referencing FIG. 6, in one embodiment the primary scientific problem has at least one physical constraint that is defined along with the associated figure. In another embodiment the physical constraint is input separately from the figure via a graphical user interface (GUI) 601. In a different embodiment the physical constraints are entered using a database or a spreadsheet. Exemplary physical constraints are shown above and not repeated here for brevity.

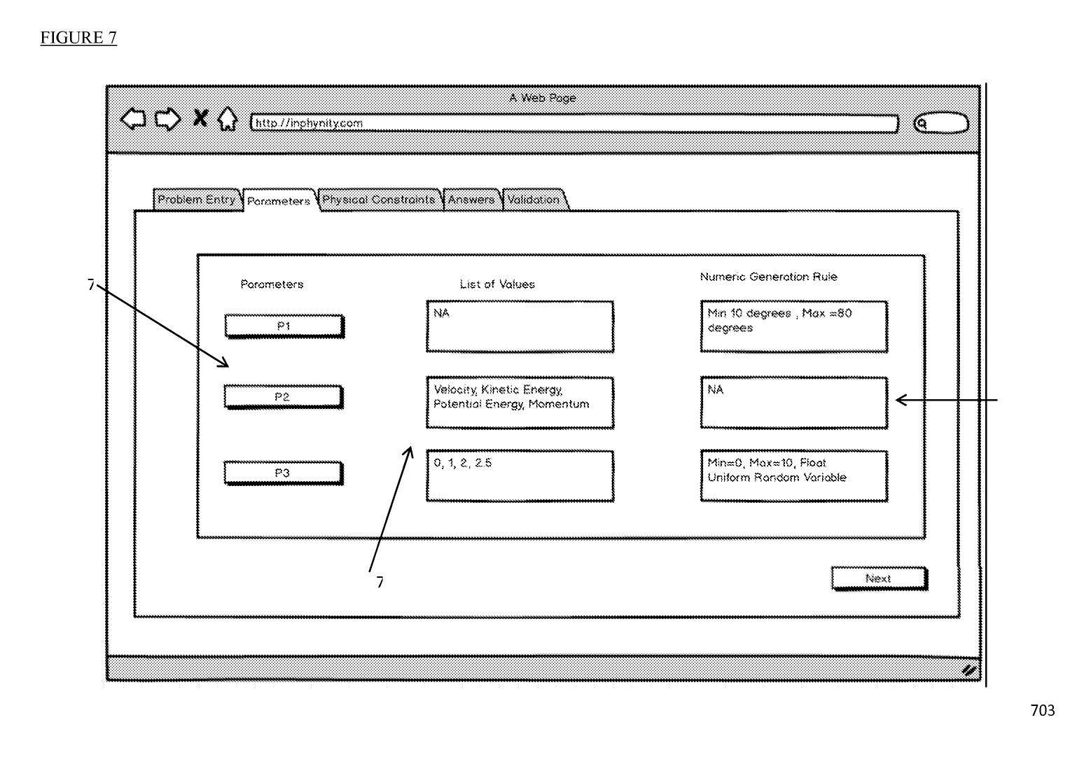

In one embodiment the primary scientific problem has at least one variable parameter that is defined along with the associated figure. Referencing FIG. 7, in another embodiment the variable parameter(s) is(are) input separately from the figure via a graphical user interface (GUI) 701. In a different embodiment the variable parameter(s) are entered using a database or a spreadsheet. For each variable parameter, an enumerated list of possible values or a mathematical technique to generate values must be specified. These values or rules may be entered through a GUI 703.

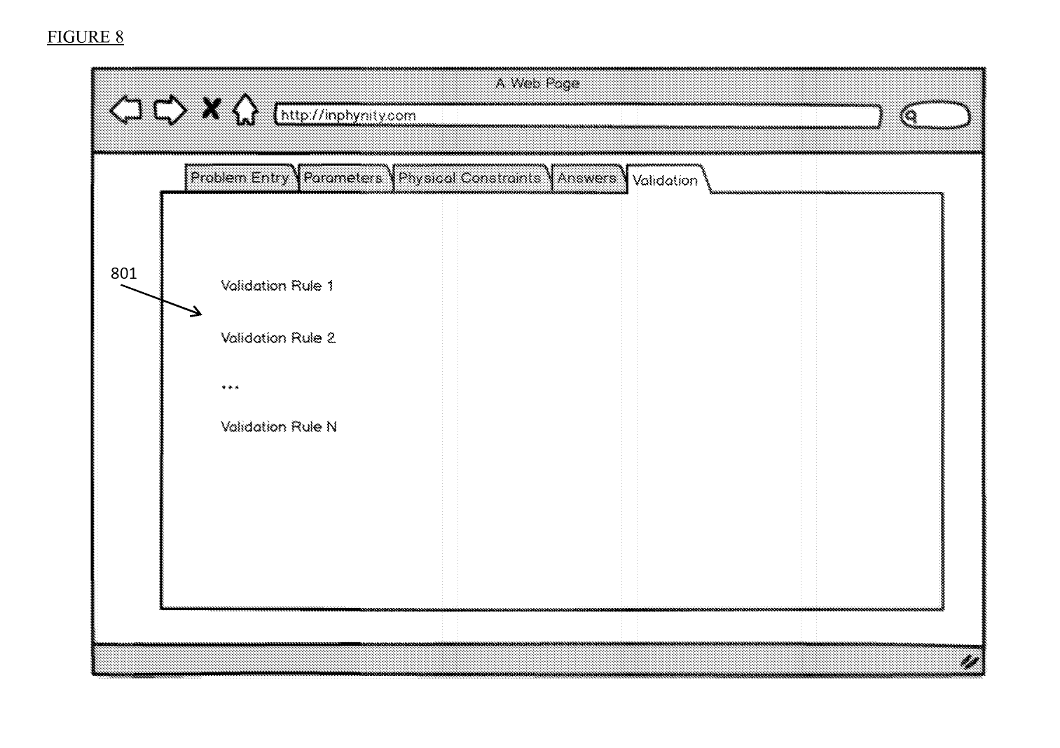

Referencing FIG. 8, in one embodiment, associated with each primary scientific problems is a set of one or more validation rules 801. These validation rules form the basis of a validation engine that is used to validate the correctness of the dynamically generated related scientific problems. An exemplary validation rule is a requirement that “if the problem asks questions on rotational inertia, then the object in question cannot be a point mass”. Another exemplary validation rule is a requirement that “if the problem asks questions on energy lost due to friction, then frictional forces cannot be absent”.

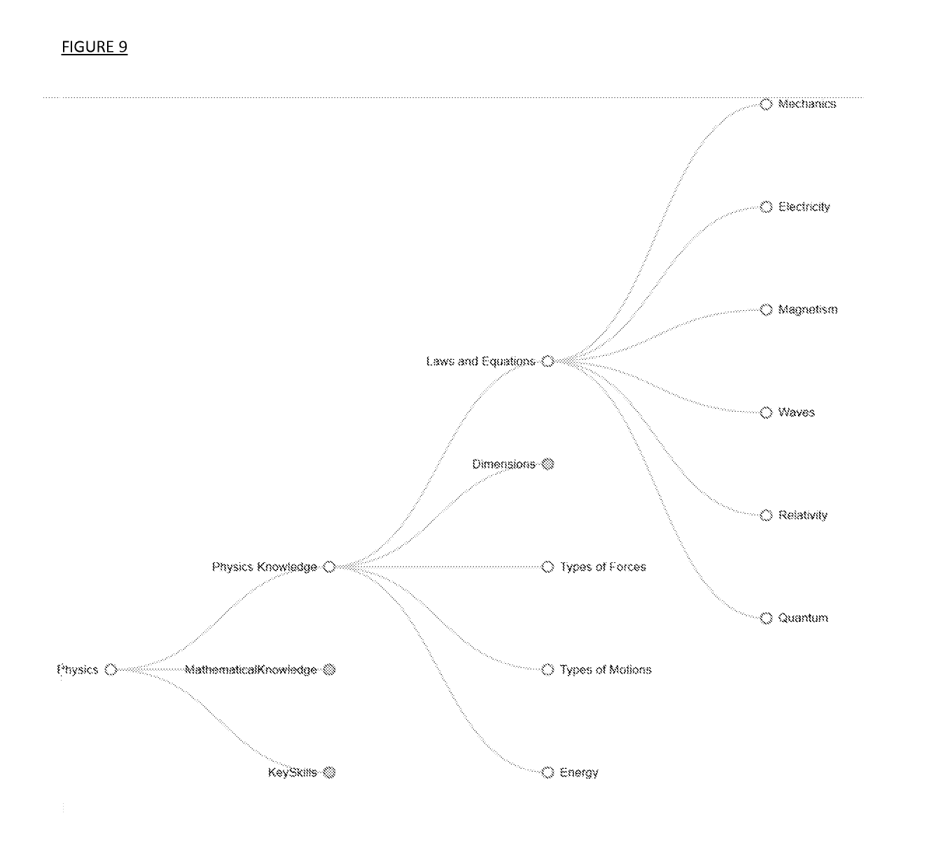

In one embodiment, associated with each primary scientific problems is a set of classification tags. Referencing FIG. 9, these classification tags could be a hierarchical set of attributes from a taxonomy of physics problem solving. These attributes could include knowledge characteristics needed to solve a particular problem (e.g., Newton's 2^{nd} Law, Kinematics Equations). These classification attributes could include concepts that go significantly beyond the world of physics and include concepts from mathematics (e.g., is knowledge of differential calculus needed?), English (e.g., is it a word problem that requires enhanced reading and comprehension skills?), level of difficulty of the problem, higher level thinking skills (e.g., does the problem require spatial visualization?), etc. The classification tags could also include real life features of the problem which may be used to serve the questions to students of a particular interest. As an example, if a problem is set in the context of an art form (e.g., asking about the moment of inertia of a rotating dancer dancing a particular type of dance), the type of dance itself could be modified depending on the interest of the student, thus making the problem more contextually relevant to the student. A student who is interested in Odissi, may thus be asked about the moment of inertia of the rotating dancer in Odissi, while a student who is interested in ballet, may be asked the same question in the context of ballet. Similarly, if a problem is asking about the motion of a vehicle, that vehicle could be dynamically modified to be a F1 racing car to students who are enthusiasts of F1 sports, or to a NASCAR to students who are enthusiasts of NASCAR, and so on.

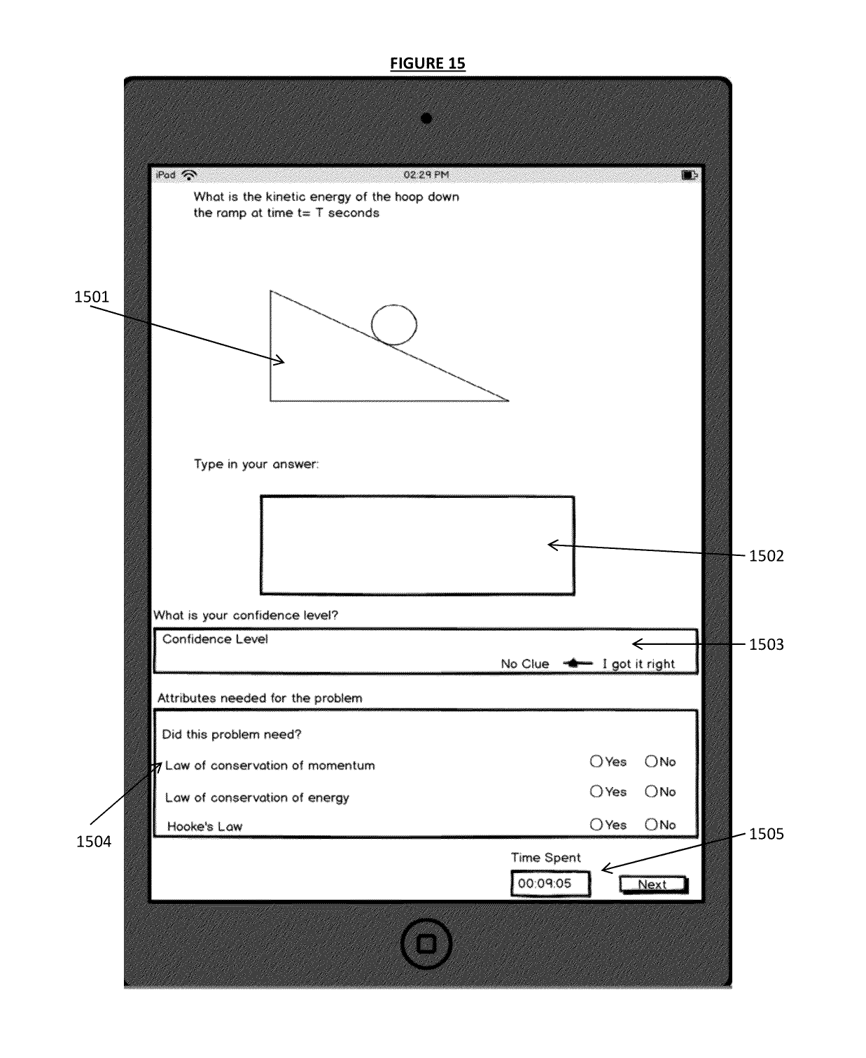

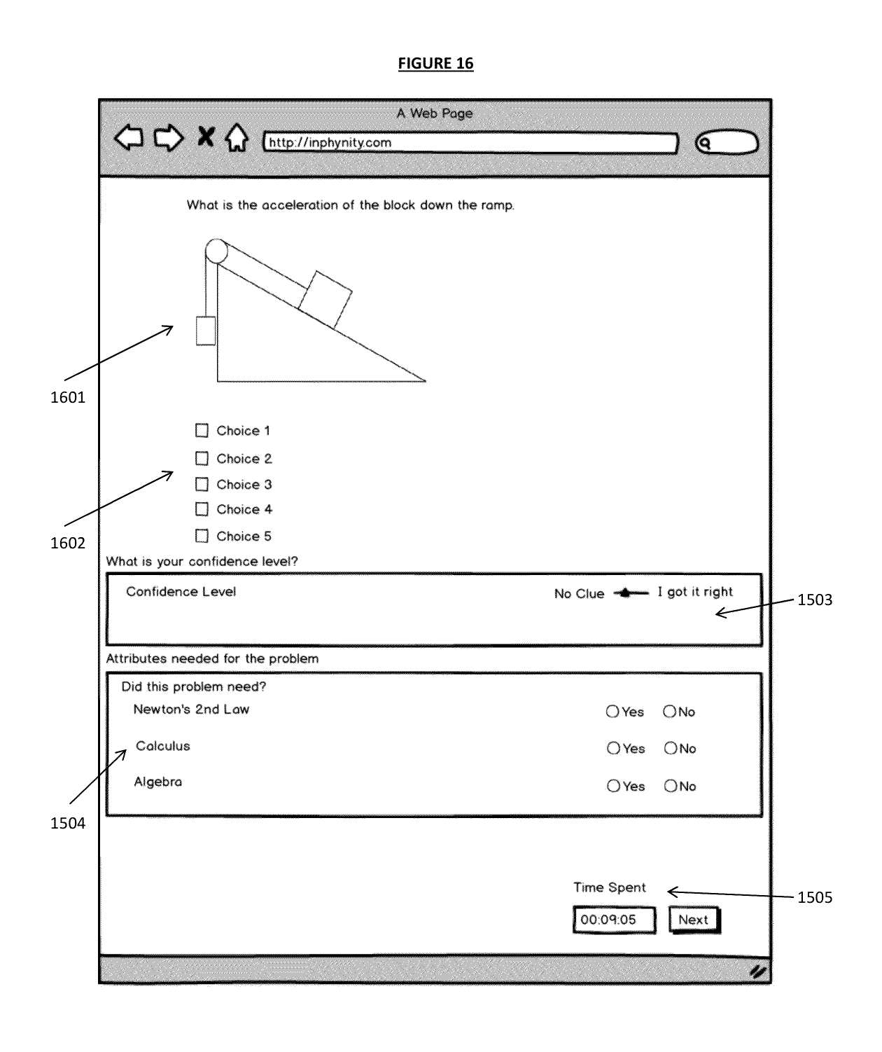

In one embodiment, the classification tags are entered via a GUI. In another embodiment the classification tags are entered via a database or a spreadsheet. In one embodiment the classification tags are from a hierarchical set that are entered via iteratively prompting the user to enter the tags for each level of the hierarchy. E.g., FIG. 15 and FIG. 16 depict an example attribute prompt 1504 for a user to classify the problem. In one embodiment, the system updates the classification tags associated with a problem by prompting the students to tag the problem with the tags that they think is appropriate. Although a student is regarded as a non-expert, and could classify a tag incorrectly, over time as a particular problem is tagged via numerous students the system can algorithmically determine the classification tags for a particular problem. This type of classification determination is referred to as “social tagging”. The overall taxonomy of physics problems could include numerous (hundreds) of tags. A particular student could be asked to enter a subset of these tags. This subset could also be a fairly small subset, maybe only a handful of tags. However, each student who is doing a particular variant of the related scientific problem could be asked to tag a different subset of the overall hierarchy. Adaptive algorithms are used to determine which students are asked which questions based on numerous factors including whether the student answered the question correctly, his or her previous propensity to tag questions accurately and so on.

During “social tagging”, the algorithm may assign a probability that a particular tag by a particular student is correct. A probability is a mathematical value between 0 and 1 that is a measure of that tag being correct. The algorithm may also anticipate and prevent malicious tagging where a particular student, or group of students intentionally and maliciously assigns incorrect tags to a particular problem.

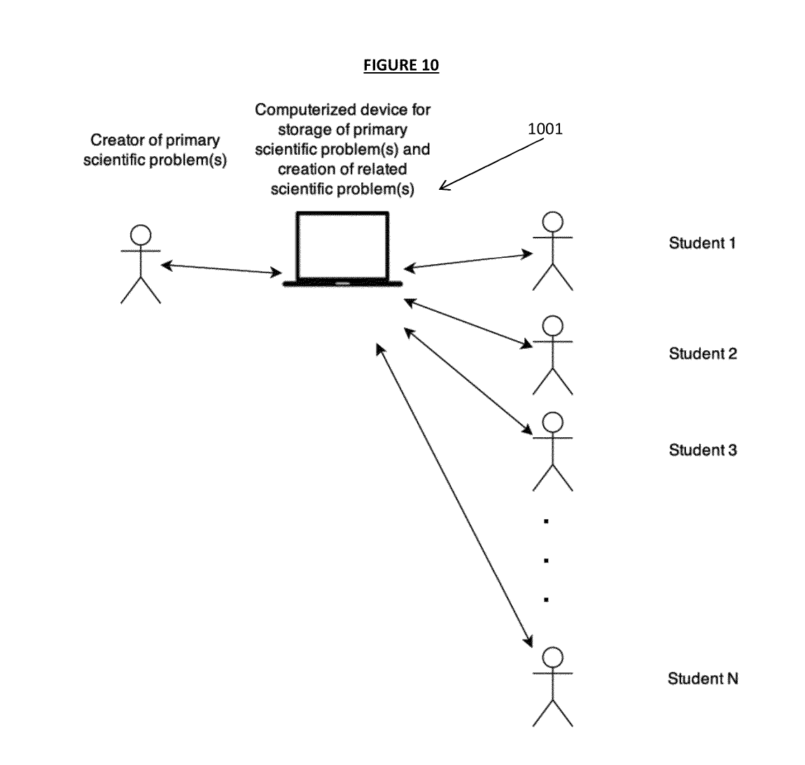

Referencing FIG. 10, in one embodiment, the primary scientific problem is stored on the first computerized device 1001. The first computerized device 1001 may be personal computers, kiosks, smart phones, or any other device capable of allowing a user to input and store data. One of ordinary skill in the art will recognize that many devices may meet the requirements of allowing a user to input and store data.

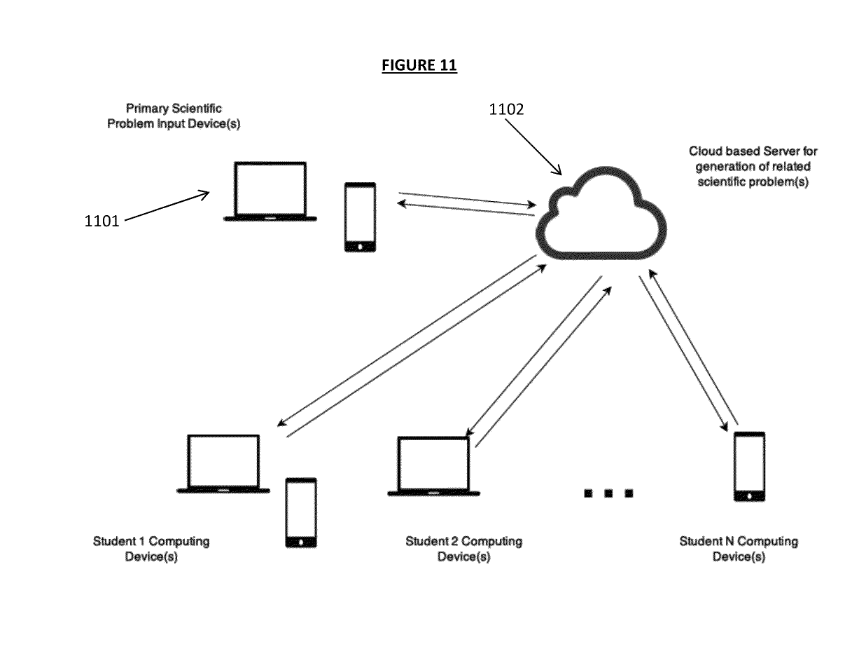

Referencing FIG. 11, in another embodiment, the first computerized device 1101 transmits the primary scientific problem to at least one server 1102 which stores the primary scientific problem in a centralized database. The primary scientific problem may be transmitted by any type of network that is capable of transmitting analog and/or digital information from one point on the network to another point on the network. Examples of these types of networks include the internet, a Bluetooth network, a cellular device network, a local area network, or a telephonic switching network. One skilled in the art will recognize that there are many network configurations capable of transmitting the analog and/or digital information necessary to perform the present invention. The server comprises an interface to connect to the network, a central processing unit (CPU) that executes computer software to perform some or all of the acts of the present invention, and an interface to connect with the data storage device and/or medium. One of ordinary skill in the art will recognize that some embodiments of the present invention may use multiple servers or CPUs to perform the operations of the present invention. The centralized database may comprise a hard disk drive, a solid state drive, RAM, or any other medium or device configured to store and retrieve information. Further, the centralized database may not be physically separate from the CPU itself, as it may comprise memory located in, on, or directly connected to the CPU, such as the CPU's internal registers and cache memory. The centralized database may or may not be physically proximate to the server. While the centralized database may typically be physically located in or near the server, it does not have to be. Many networks and methodologies exist that allow a server to send and retrieve information to and from a remote centralized database, such as typical network storage devices. Further, some exemplary embodiments of the present invention may use multiple databases for information storage and/or retrieval. One of ordinary skill in the art will recognize that other types of information may be stored and read from the centralized database, as required by the particular embodiment of the present invention.

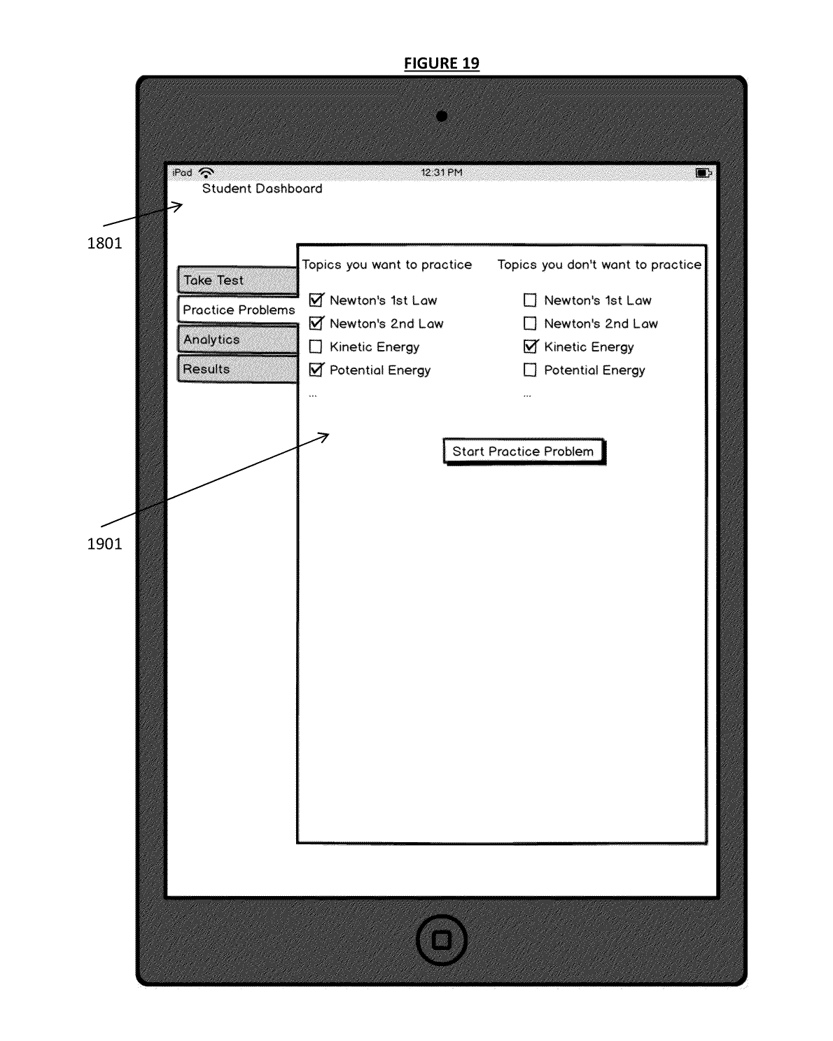

In a different embodiment, the first computerized device transmits the primary scientific problem, perhaps through a centralized server, to the client computers and the database is stored at each client computer, updated periodically as newer primary scientific problems are created. In yet another embodiment, a second computerized device is used to enter the desired features of the related scientific problem. This last use case is typically used by teachers, who may want to use the system to generate related scientific problems of a specific kind (e.g., teachers may want all the related scientific problems to feature friction between the object on the inclined plane and the inclined plane). The student, via her computerized device could also specify specific desirable (and undesirable) features of the derived scientific problems. E.g., referencing FIG. 19 as an example, the student, via a GUI 1801, or otherwise, could specify that she wants to practice problems 1901 featuring Newton's 1^{st} Law, 2^{nd} Law and Potential Energy, but not including Kinetic Energy. Referencing FIG. 18, in another embodiment the student, via a GUI 1801, or otherwise, could select a topic area she wants to practice problems in 1802. These embodiments are given as exemplary cases and are not meant to be limiting. There could be numerous other configurations of where the primary scientific problem is stored, where the related scientific problems are generated, and who gets to choose the features of the derived scientific problem.

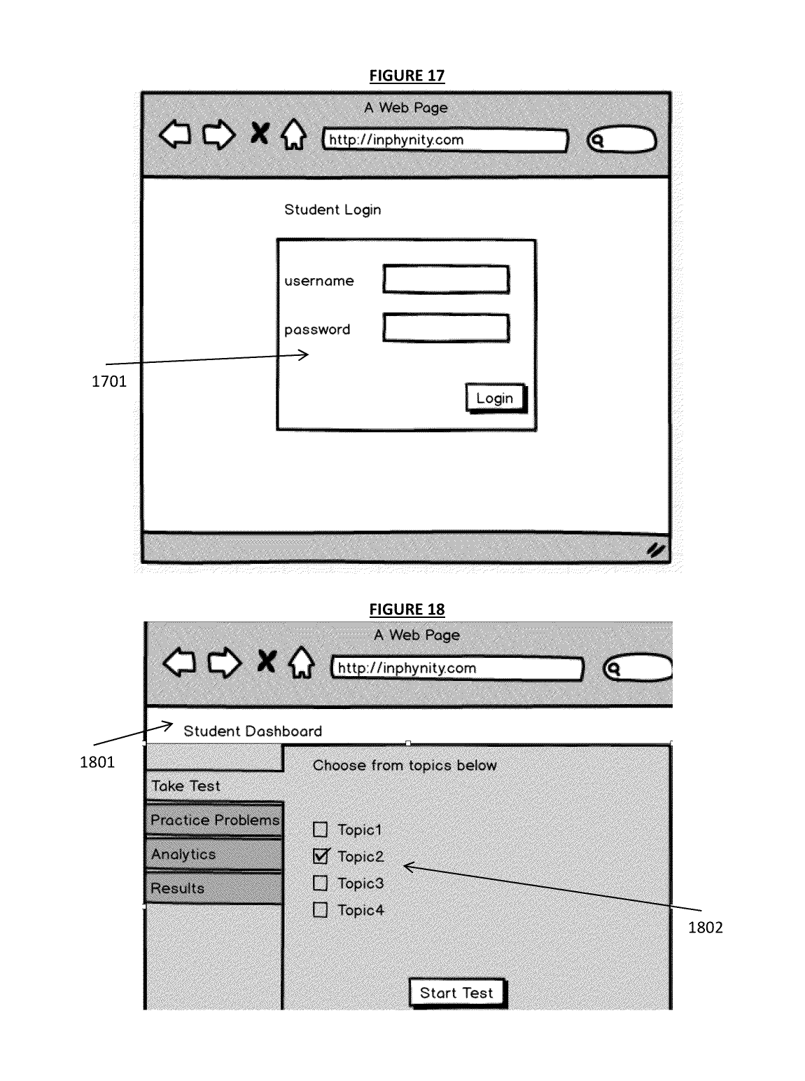

In one embodiment, the system generates one derived scientific problem at a time and presents it to a particular user. In yet another embodiment, the system may be asked to generate a particular number of derived scientific problems simultaneously. The first case is generally preferred when students are practicing problems one at a time, typically at a user/client computer. Referencing FIG. 17, the student would login 1701 to the system to access the problems desired. The second use case is generally preferred when a teacher wants to print out homework sheets or create a handout or publishable book that can be physically handed over to a student. Thus, this invention also discloses a system to efficiently generate a large number of problem sets that may be used to print and publish a book of scientific problems.

In addition to choosing features of the derived scientific problem based on human choice, in one embodiment, the system dynamically chooses features of the derived scientific problem. In one embodiment, the system chooses features based on student profile. E.g., the student profile could indicate a particular student has a certain age, is enrolled in a particular class, has a particular grade point average (GPA) in school, has an interest in particular sports, etc. The features of the student profile featured are not meant to be exhaustive but are exemplary in nature. The student features themselves could be explicitly entered by the user through a GUI, or learnt by the system based on computer cookies. Learning user interest via tracking cookies is well known in the art and is not exhaustively described in this disclosure. Once a particular student's profile is learnt by the system, it can compare it with other student profiles in the database and serve problems that other students with similar profiles requested.

In yet another embodiment the system dynamically chooses features of the derived scientific problem based on user performance. In this embodiment, the system keeps track of user performance based on numerous metrics. Some of these metrics include “time taken to solve a problem correctly”, “classification features of problems solved correctly”, “classification features of problems solved incorrectly”, “level of difficulty of problems solved correctly (or incorrectly)”, “confidence level of correct solution as indicated by student”, “classification features of problems solved in the recent past”, etc. Again, these metrics are meant to be exemplary, not exhaustive. Based on these metrics, the system can choose the features of a new derived scientific problem. E.g., if the system observes that a particular student can solve problems on Newton's 2nd Law that involve algebra, but usually fails to solve problems on Newton's 2nd Law when the math involves calculus, then the algorithm can serve problems just on calculus to the student. This helps the student improve the skills in which they are deficient in. Alternately, the system could also choose to serve the student problems in his areas of strength in order to boost levels of confidence and comfort with the subject.

It should be highlighted that the above embodiments for the determination of the features of the derived scientific problem are not mutually exclusive. A particular embodiment could adopt some or all aspects of each of the embodiments above and still be within the scope of the disclosure.

Based on continued use of the system, a particular student's strength and weaknesses in the particular scientific subject being tested can be determined. These strengths and weaknesses can be displayed to the user via student/teacher dashboards 1801. The system can be used to keep track of performance in a particular topic area to see how it improves over time.

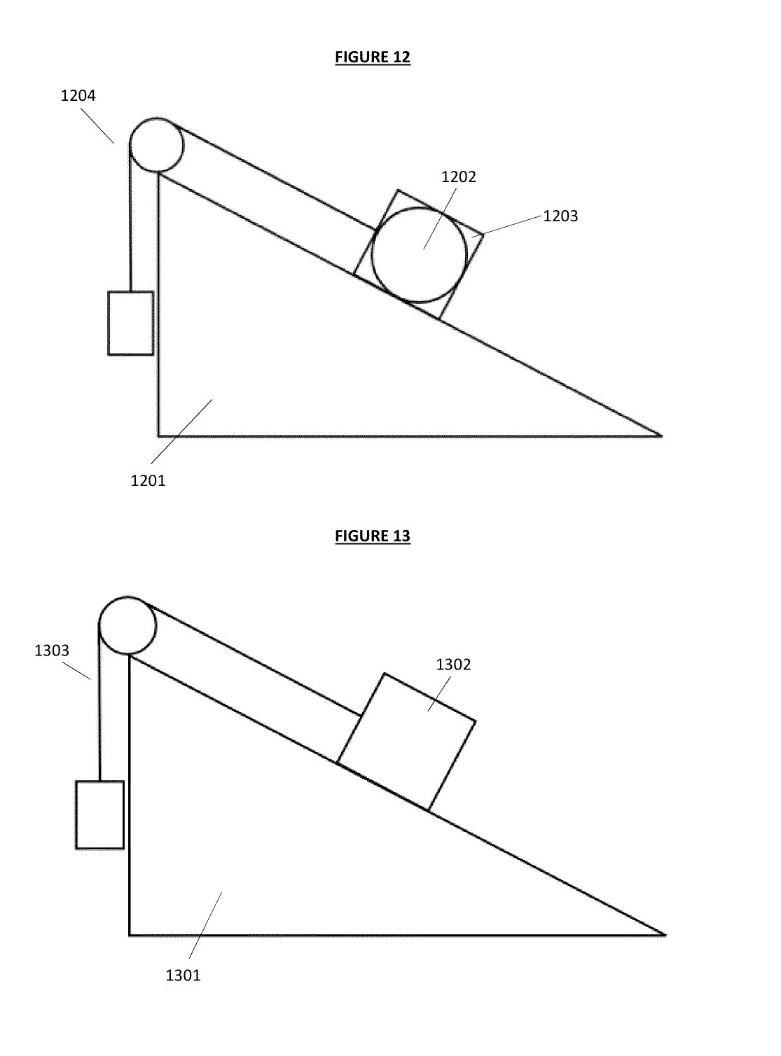

Once a particular set of features and physical constraints for a particular related scientific problem is determined, the system has to generate the particular scientific problem. As an exemplary case, from the primary scientific problem of the “object on an inclined ramp”, suppose it has been determined that a related scientific problem with “a pulley”, and “with a block” will be generated and that the student will be asked questions on “Newton's 2nd Law”. In an embodiment the first step in the generation process is to dynamically generate the appropriate figure. If the figure associated with the primary scientific problem is stored in the SVG format, generating the appropriate figure for the derived scientific problem comprises sending parameters to the SVG image definition turning on or turning off certain features. E.g., FIG. 12 depicts a generic figure associated with the primary scientific problem of the “object on an inclined ramp”. The generic image features an inclined ramp 1201, a pulley with a mass hanging off of it 1204, and two objects on the ramp—a block 1203 and a hoop 1202. An example of the associated SVG code to depict this generic image is:

```
<svg width=“600” height=“600” xmlns=“http://www.w3.org/2000/svg” xmlns:svg=“http://www.w3.org/2000/svg”>
  <g>
    <title>Composite SVG Image for Primary Scientific Problem</title>
    <!-- This Draws the Inclined Ramp -->
    <path stroke=“#000000” id=“svg_1” d=“m122.038498,428.199005I0,−238.198807I456.400467,238.198807I-
          456.400467,0z” stroke-width=“2” fill=“#ffffff”/>
    <!-- This Draws the Block on the Ramp -->
    <rect transform=“rotate(27.8417 357.529 263.617)” fill=“#ffffff” stroke-width=“2”
          stroke-dasharray=“null” stroke-linejoin=“null” stroke-linecap=“null” x=“313.6893”
          y=“220.474857” width=“87.678534” height=“86.285304” id=“svg_9” stroke=“#000000”/>
    <!-- This Draws the Hoop on the Ramp -->
    <circle cx=“358.125001” cy=“263.875” r=“42.874998” stroke-width=“2” fill=“#ffffff” id=“svg_2” stroke=“#000000”/>
    <!-- This Draws the Pulley with the mass on the ramp -->
    <circle cx=“120.476998” cy=“164.498” r=“24.25” stroke-width=“2” fill=“#ffffff” id=“svg_4” stroke=“#000000”/>
    <line fill=“none” stroke-width=“2” stroke-dasharray=“null” stroke-linejoin=“null” stroke-linecap=“null” x1=“135.60199”
          y1=“145.373001” x2=“319.935322” y2=“242.039671” id=“svg_5” stroke=“#000000”/>
    <rect fill=“#ffffff” stroke-width=“2” stroke-dasharray=“null” stroke-linejoin=“null”
          stroke-linecap=“null” x=“76.851991” y=“297.206345” width=“40.249999” height=“57” id=“svg_8”
          stroke=“#000000”/>
    <line fill=“none” stroke-width=“2” stroke-dasharray=“null” stroke-linejoin=“null”
          stroke-linecap=“null” x1=“96.185322” y1=“161.706329” x2=“96.935322” y2=“297.206324” id=“svg_11”
          stroke=“#000000”/>
  </g>
</svg>
```

Since in this example, the ramp, the pulley, and the block are desired, but not the hoop, the dynamically generated figure must not render the hoop. An exemplary way to do this is to comment out the SVG code responsible for the depiction of the hoop. In this SVG example, comments are indicated by “<!-” and “->” and thus the computerized device responsible for the generation of the related image, inserts the comment tags in front of the code for the hoop. The dynamically generated figure for the associated figure is shown in FIG. 13. The associated code is given by (note the additional comment tags/parameters that have been inserted to ensure that the hoop is not generated. In a different embodiment, instead of commenting out the SVG code responsible for the rendering of the hoop, the hoop may be drawn with a “stroke-width” parameter set to 0 (this ensures that the hoop is invisible). In yet another embodiment, the line of the hoop is drawn in the same color as that of the background of the image (e.g., by setting “stroke=white” to draw a hoop in white against a white background). In each of these embodiments, the undesired element of the generic image associated with the primary scientific image is not drawn (or is rendered invisible), thus dynamically generating a new image appropriate for the related scientific problem. E.g., the generic image now features an inclined ramp 1301, a pulley with a mass hanging off of it 1303, and one object on the ramp—a block 1302. The associated SVG code to depict this might look like:

```
<svg width=“600” height=“600” xmlns=“http://www.w3.org/2000/svg” xmlns:svg=“http://www.w3.org/2000/svg”>
  <g>
    <title>Composite SVG Image for Primary Scientific Problem</title>
    <!-- This Draws the Inclined Ramp -->
    <path stroke=“#000000” id=“svg_1” d=“m122.038498,428.199005I0,−238.198807I456.400467, 238.198807I-
456.400467,0z”
stroke-width=“2” fill=“#ffffff”>
    <!-- This Draws the Block on the Ramp -->
    <rect transform=“rotate(27.8417 357.529 263.617)” fill=“#ffffff” stroke-width=“2”
          stroke-dasharray=“null” stroke-linejoin=“null” stroke-linecap=“null” x=“313.6893”
          y=“220.474857” width=“87.678534” height=“86.285304” id=“svg_9” stroke=“#000000”/>
    <!-- This Draws the Hoop on the Ramp -->
    <!-- Comment Tags dynamically generated by computer
    <circle cx=“358.125001” cy=“263.875” r=“42.874998” stroke-width=“2” fill=“#ffffff” id=“svg_2” stroke=“#000000”/>
    -->
    <!-- This Draws the Pulley with the mass on the ramp -->
    <circle cx=“120.476998” cy=“164.498” r=“24.25” stroke-width=“2” fill=“#ffffff” id=“svg_4” stroke=“#000000”/>
    <line fill=“none” stroke-width=“2” stroke-dasharray=“null” stroke-linejoin=“null” stroke-linecap=“null” x1=“135.60199”
          y1=“145.373001” x2=“319.935322” y2=“242.039671” id=“svg_5” stroke=“#000000”/>
    <rect fill=“#ffffff” stroke-width=“2” stroke-dasharray=“null” stroke-linejoin=“null” stroke-linecap=“null” x=“76.851991”
          y=“297.206345” width=“40.249999” height=“57” id=“svg_8” stroke=“#000000”/>
    <line fill=“none” stroke-width=“2” stroke-dasharray=“null” stroke-linejoin=“null” stroke-linecap=“null” x1=“96.185322”
          y1=“161.706329” x2=“96.935322” y2=“297.206324” id=“svg_11” stroke=“#000000”/>
  </g>
</svg>
```

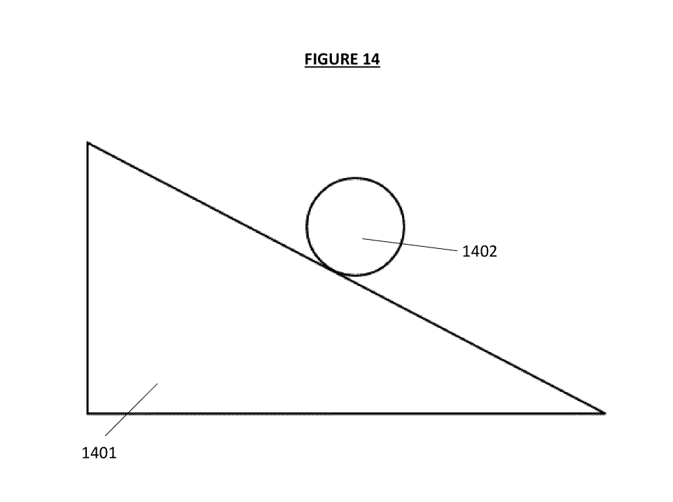

In a different example of a different related scientific problem related to the same primary scientific problem above, if it is desired to depict a ramp with only a hoop on it (without a block or pulley system), then the associated figure is shown in FIG. 14, showing an incline ramp 1401 and a hoop 1402 on the ramp. The associated code is shown below where comment tags are added in front of the block and the pulley system to ensure that those do not get drawn.

```
<svg width=“600” height=“600” xmlns=“http://www.w3.org/2000/svg” xmlns:svg=“http://www.w3.org/2000/svg”>
  <g>
    <title>Composite SVG Image for Primary Scientific Problem</title>
    <!-- This Draws the Inclined Ramp -->
    <path stroke=“#000000” id=“svg_1” d=“m122.038498,428.199005I0,−238.198807I456.400467,238.198807I-
          456.400467,0z” stroke-width=“2” fill=“#ffffff”/>
    <!-- This Draws the Block on the Ramp -->
    <!-- Comment Tags dynamically generated by computer
    <rect transform=“rotate(27.8417 357.529 263.617)” fill=“#ffffff” stroke-width=“2” stroke-dasharray=“null” stroke-
          linejoin=“null” stroke-linecap=“null” x=“313.6893” y=“220.474857” width=“87.678534” height=“86.285304”
          id=“svg_9” stroke=“#000000”/>
    -->
    <!-- This Draws the Hoop on the Ramp -->
    <circle cx=“358.125001” cy=“263.875” r=“42.874998” stroke-width=“2” fill=“#ffffff” id=“svg_2” stroke=“#000000”/>
    <!-- This Draws the Pulley with the mass on the ramp -->
    <!-- Comment Tags dynamically generated by computer
    <circle cx=“120.476998” cy=“164.498” r=“24.25” stroke-width=“2” fill=“#ffffff” id=“svg_4” stroke=“#000000”/>
    <line fill=“none” stroke-width=“2” stroke-dasharray=“null” stroke-linejoin=“null”
          stroke-linecap=“null” x1=“135.60199” y1=“145.373001” x2=“319.935322” y2=“242.039671” id=“svg_5”
          stroke=“#000000”/>
    <rect fill=“#ffffff” stroke-width=“2” stroke-dasharray=“null” stroke-linejoin=“null” stroke-linecap=“null” x=“76.851991”
          y=“297.206345” width=“40.249999” height=“57” id=“svg_8” stroke=“#000000”/>
    <line fill=“none” stroke-width=“2” stroke-dasharray=“null” stroke-linejoin=“null” stroke-linecap=“null” x1=“96.185322”
          y1=“161.706329” x2=“96.935322” y2=“297.206324” id=“svg_11” stroke=“#000000”/>
    -->
  </g>
</svg>
```

The exemplary case above discloses the dynamic generation of images by turning on or off specific elements of the image associated with the primary scientific problem. In addition to turning elements on or off, other modifications could also have been made. E.g., the image parameter indicating the angle of inclination of the ramp could be changed, thus dynamically generating a ramp that is steeper (or less steep). The size of the object on the ramp could have been changed. Colors may have been changed. SVG images control numerous aspects of the image via parameters that may be dynamically changed.

As can be seen from the above disclosure, the related scientific problem could have a different image that is dynamically generated by the computerized device by passing parameters/tags to the description of the generic figure stored along with the primary scientific problem definition.

In a different embodiment, the images are stored as .jpg or .gif or .bmp formats. These are not dynamically generated and so a plurality of images are stored along with the primary scientific problem definition. In this embodiment, the system has to determine which of the images depicts the features/constraints to be featured in the derived scientific problem and then that particular image is to be used.

The next step in generating the derived scientific question is to determine the question to be asked. In this exemplary case, a question on “Newton's 2nd Law”, could be “What is the {variable X} of the block down the slope?” {variable X} could come from a list of enumerated values such as {acceleration, velocity at time t=0, velocity at time t=1 second}. In one embodiment the items from the list are chosen sequentially each time a new related scientific problem is to be generated. In another embodiment the items from the list are chosen randomly. In yet another embodiment, the items are chosen based on what was previously asked. Once a particular item is chosen from the list, the variable is replaced and thus the question in this exemplary case becomes, “What is the acceleration of the block down the slope?” In one embodiment to ensure grammatical correctness, the generated question is then passed through a standard grammar check engine and grammatically corrected as appropriate.

In one embodiment, once the question has been generated, it is verified as correct by iteratively passing through a set of rules and ensuring the validity check rules pass. A particular rule could be the equivalent of “if questions on rotational motion are asked, the object on the ramp cannot be a point mass”, or “if questions related to friction are asked, friction cannot be absent” and so on.

Referencing FIG. 15, in one embodiment, the system generates just the question without providing any answers 1502. This is typically the case for what are referred to as free response questions. In this embodiment an external entity (could be a human or a computerized device), grades the student's answers and provides it as input to the system being disclosed. In yet another embodiment, the system determines the correct answer and gives feedback to the student as to whether the student's answer is correct or not.

Referencing FIG. 16, in yet another embodiment, the system is a multiple choice question where the system determines the correct answer, and presents the user with a specified number of choices 1602 where at least 1 is correct, and the user, via a GUI, enters her choice of the answer. In an embodiment, the student is also prompted via a confidence meter or slider or dial 1503, to indicate her general confidence about being able to answer the question correctly.

In order to determine the correct answer the primary scientific problem must have a set of solutions that are available in the database. Referencing FIG. 5, the set of solutions may be stored in very generic formulaic manner 501. E.g., for the acceleration, a, of the block down the ramp the general equation is:

$$a = \{ \begin{matrix}0 & \begin{matrix}if ( T + F cos φ ) \leq {M}_{1} g sin θ \leq \\ ( T + F cos φ ) + {μ}_{s} ( {M}_{1} g cos θ - F sin φ )\end{matrix} \\ 0 & \begin{matrix}if {M}_{1} g sin θ < ( T + F cos φ ) \leq \\ {M}_{1} g sin θ + {μ}_{s} ( {M}_{1} g cos θ - F sin φ )\end{matrix} \\ \frac{1}{{M}_{1}} [ \begin{matrix}{M}_{1} g sin θ - F cos φ - T - \\ {μ}_{k} ( {M}_{1} g cos θ - F sin φ )\end{matrix} ] & \begin{matrix}if {M}_{1} g sin θ > T + F cos φ + \\ {μ}_{s} ( {M}_{1} g cos θ - F sin φ )\end{matrix} \\ \frac{1}{{M}_{1}} [ \begin{matrix}{M}_{1} g sin θ - F cos φ - T + \\ {μ}_{k} ( {M}_{1} g cos θ - F sin φ )\end{matrix} ] & \begin{matrix}if {M}_{1} g sin θ + \\ {μ}_{s} ( {M}_{1} g cos θ - F sin φ ) < T + F cos φ\end{matrix}\end{matrix}$$

Where M₁ is the mass of the block, θ is the angle of inclination of the ramp, T is the tension of the string connected to the block and pulley, F is an external force applied up the ramp at an angle of φ to the ramp's surface, μₖ is the coefficient of kinetic friction, and μₛ is the coefficient of static friction. The related scientific problem in this particular case had no external force, and no pulley; hence when evaluating the correct solution to the related scientific problem, T=F=0. The values of the other variables can be numeric in one embodiment and symbolic in a different embodiment. If they are numeric, then the primary scientific problem definition includes rules for generation of each parameter. E.g., for the coefficients of static and kinetic frictions, they may both be specified as floating point numbers with 1 decimal place with the physical constraint of 0−μₖ<μₛ≦1. For the angle of inclination of the ramp, 10°≦θ≦80° may be a preferred embodiment. The key point is that the primary scientific problem defines its answer in very general terms which are then used to evaluate the correct response of the related scientific problems.

In one embodiment, after a correct answer has been determined, the system also has to generate incorrect answer choices to form a set of multiple choice question choices that are presented to the user via a client/user computerized device. In a different embodiment, instead of presenting the answer choices via a client/user computerized device, the related scientific question, together with the answer choices, are printed out on paper or published in a book for users to solve.

In order to generate the incorrect multiple choice questions, different enabling practices may be followed. In a particular embodiment, the incorrect answer choices are generated by applying different multiplicative factors. E.g., if the correct answer has a numerical value of x, the incorrect choices have values of α₁x, α₂x, α₃x, and so on, where α₁, α₂, α₃, are numerical constants like 0.5, 2, 10, etc. If the answer choice is symbolic, instead of numeric, similarly, the incorrect choices can be made to be numeric scale factors of the correct answer. In one embodiment, the position of the correct answer in the list of answer choices is selected randomly. Other embodiments well within the scope of this disclosure would be obvious to a person having ordinary skill in the art of designing multiple choice questions.

In the context of this disclosure, a computerized device may be a device that is commonly viewed as a device with computing power. Without being exhaustive, some exemplary computerized devices include personal computers, desktops, laptops, tablet computers, iPads, smart phones, iPhones, Android Phones, Google Glass, PS2 PlayStation, etc. Generally any device with a user interface for taking user input, a display medium for displaying visual content to a user, and computing resources can be considered to be a computerized device. In one embodiment, the computing resources are located at the customer premises. In a different embodiment, the computing resources are virtual and located on the cloud (a field called cloud computing). E.g., the depiction displayed in FIG. 11, 1102. In a similar vein, references to a server in this disclosure do not necessarily refer to a particular device, but could be referring to a distributed class of server devices as are commonly available for a server like functionality for cloud computing.

Referring to this disclosure as a whole, different implementations and exemplary embodiments of the present invention have been described. It will become apparent to one skilled in the art that many of the actions described may be performed in a different manner and in different orders, and that some of the actions described may not need to be performed in order to implement the teachings of the invention as described herein

We claim:

1. A computerized system for generation of educational content, comprising:
a computerized device configured to:
receive an input of a primary scientific problem comprising an at least one variable parameter, at least one physical constraint, and a corresponding figure from a user; and
generate at least one related scientific problem by varying the at least one variable parameter and the physical constraint of the primary scientific problem.

2. The computerized system of claim 1, wherein the computerized device is further configured to generate a prompt for the related scientific problem.

3. The computerized system of claim 2, wherein the computerized device is further configured to apply a natural language processor to the prompt.

4. The computerized system of claim 1, further comprising a database configured to store the primary scientific problem.

5. The computerized system of claim 4, wherein the computerized device is further configured to convert the corresponding figure into a scalable vector graphic and store the scalable vector graphic in the database.

6. The computerized system of claim 1, wherein the computerized device is further configured to validate the related scientific problem through the iterative application of problem validation rules relating to mathematical and physical properties.

7. The computerized system of claim 1, wherein the computerized device is further configured to take as input user preferences or interests and use them to generate a contextually interesting related scientific problem.

8. The computerized system of claim 1, wherein the computerized device is further configured to generate a related scientific problem with a desired taxonomy classification.

9. A computerized system for generation of educational content, comprising:
a first computerized device configured to:
receive an input of a primary scientific problem comprising an at least one variable parameter, at least one physical constraint, and a corresponding figure from a user; and
a server configured to:
receive the primary scientific problem from the first computerized device;
store the primary scientific problem in a database;
generate a related scientific problem by varying the at least one variable parameter and the physical constraint of the primary scientific problem;
generate at least one prompt for the related scientific problem;
generate an answer for the at least one prompt;
transmit the related scientific problem and the prompt to the second computerized device;
receive the user's input from the second computerized device; and
compare the user's input to the answer, and according to whether the user correctly answered the question, iteratively generate a plurality of related scientific problems, prompts, and answers; and
a second computerized device configured to:
receive the related scientific problem, the prompt, and the answer from the server;
display the related scientific problem and the prompt to the user; and
receive the user's input to the related scientific problem; and
transmit the user's input to the server.

10. The computerized system of claim 9, wherein the server is further configured to apply a natural language processor to the prompt.

11. The computerized system of claim 9, wherein the server is further configured to convert the corresponding figure into a scalable vector graphic and store the scalable vector graphic in the database.

12. The computerized system of claim 9, wherein the server is further configured to validate the related scientific problem through the iterative application of problem validation rules relating to mathematical and physical properties.

13. A computerized method for generation of educational content, comprising the acts of:
creating, by a computerized device, a primary scientific problem comprising an at least one variable parameter, at least one physical constraint, and a corresponding figure; and
generating, by the computerized device, at least one related scientific problem by varying the at least one variable parameter and the physical constraint.

14. The computerized method of claim 13, further comprising generating, by the computerized device, a prompt for the related scientific problem.

15. The computerized method of claim 14, further comprising correcting the grammatical syntax of the prompt, by the computerized device, through applying a natural language processor.

16. The computerized method of claim 13, further comprising storing in a database, by the computerized device, the primary scientific problem.

17. The computerized method of claim 16, further comprising converting the corresponding figure to a scalable vector graphic, by the computerized device, and storing the scalable vector graphic in the database.

18. The computerized method of claim 13, further comprising validating the related scientific problem, by the computerized device, by iteratively applying problem validation rules relating to scientific and physical properties.

19. The computerized method of claim 13, further comprising generating, by the computerized device, a contextually interesting scientific problem by taking into consideration user preferences or interests.

20. The computerized method of claim 13, further comprising generating, by the computerized device, a related scientific problem with a desired taxonomy classification.
